(19) United States
(12) Patent Application Publication
(10) Pub. No.: US 2003/0092413 A1
(43) Pub. Date: May 15, 2003

(54) Satellite radio

(75) Inventor: Toshiyuki Ito, Hadano-shi (JP)

Correspondence Address: SHINJYU GLOBAL IP COUNSELORS, LLP, 1233 20TH STREET, NW, SUITE 700, WASHINGTON, DC, 20036-2680, US

(73) Assignee: Nissan Motor Co., Ltd., Yokohama (JP)

(21) Appl. No.: 10/243,675

(22) Filed: Sep. 16, 2002

(30) Foreign Application Priority Data
Nov. 15, 2001 (JP) JP2001-349943

(51) Int. Cl. H04H 1/00; H04B 1/06; H04B 7/00

(52) U.S. Cl. 455/234.1; 455/251.1; 455/3.02

(57) ABSTRACT

A satellite radio is configured to receive a digital broadcast signal from a satellite, and to prevent abrupt changes in sound volume level that startle the driver and accompanying passengers from occurring. The satellite radio preferably has a microcomputer with a reception determining section and a sound volume controlling section. The reception determining section determines the strength (e.g., receivable or not receivable) of the broadcast signal. The sound volume controlling section controls the sound volume level in response to the strength of the broadcast signal. The sound volume controlling section mutes or reduces the sound volume level when the broadcast signal is below a first predetermined reception level. Thereafter the sound volume controlling section gradually increases the sound volume level when the strength of the broadcast signal has changed from the first predetermined reception level to a second predetermined reception level.

### BACKGROUND OF THE INVENTION

1. Field of the Invention

The present invention relates to a satellite radio that receives a digital broadcast signal from a broadcast satellite or communications satellite. More particularly, the present invention relates to satellite radios that are installed in automobiles and other vehicles.

2. Background Information

The transmission frequencies of the digital broadcasts transmitted from satellites and received by satellite radios are in the GHz band, for example, 2.3 GHz in the United States. Recently, automobiles and other vehicles are optionally provided with a satellite radio that receives a digital broadcast signal from a broadcast satellite or communications satellite. Consequently, when a satellite radio is installed in automobiles and other vehicles, special problems exists compared to a stationary satellite radio.

It will be apparent to those skilled in the art from this disclosure that there exists a need for an improved satellite radio. This invention addresses this need in the art as well as other needs, which will become apparent to those skilled in the art from this disclosure.

### SUMMARY OF THE INVENTION

It has been discovered that when an obstruction exists between the antenna and the satellite, the broadcast signal cannot be received at all and the sound is lost by the satellite radio.

Consider an automobile carrying a passenger who is listening to music with a satellite radio that is receiving a broadcast signal from a satellite. If the automobile enters a tunnel, for example, and then emerges from the tunnel after a short while, at the exit of the tunnel the sound will change suddenly from no sound to the sound volume level heard at the entrance before entering the tunnel. This kind of sudden change in sound volume level may startle the driver and other passengers.

Of course, this phenomenon is not limited to tunnels. It can occur anytime the vehicle suddenly moves from a location where the satellite broadcast signal cannot be received to a location where the satellite broadcast signal can be received, such as when traveling in a roofed parking garage or under an overpass.

One object of the present invention is to provide a satellite radio that can prevent abrupt changes in sound volume level that may startle the driver and/or the accompanying passengers.

In order to achieve the aforementioned object, a satellite radio is provided that comprises a digital broadcast receiving section, a reception determining section and a sound volume controlling section. The digital broadcast receiving section is configured to receive a digital broadcast signal from a satellite. The reception determining section is configured to determine strength of the broadcast signal. The sound volume controlling section is configured to regulate a sound volume level outputted in response to the strength of the broadcast signal determined by the reception determining section.

This object and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a block diagram of a receiving circuit of a satellite radio in accordance with one embodiment of the present invention;

FIG. 2 is a graphical illustration of a sound volume control executed in the satellite radio illustrated in FIG. 1 in accordance with one embodiment of the present invention; and

FIG. 3 a graphical illustration that compares a radio using conventional analog broadcasting technology to a satellite radio using the concept illustrated in FIGS. 1 and 2 in accordance the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

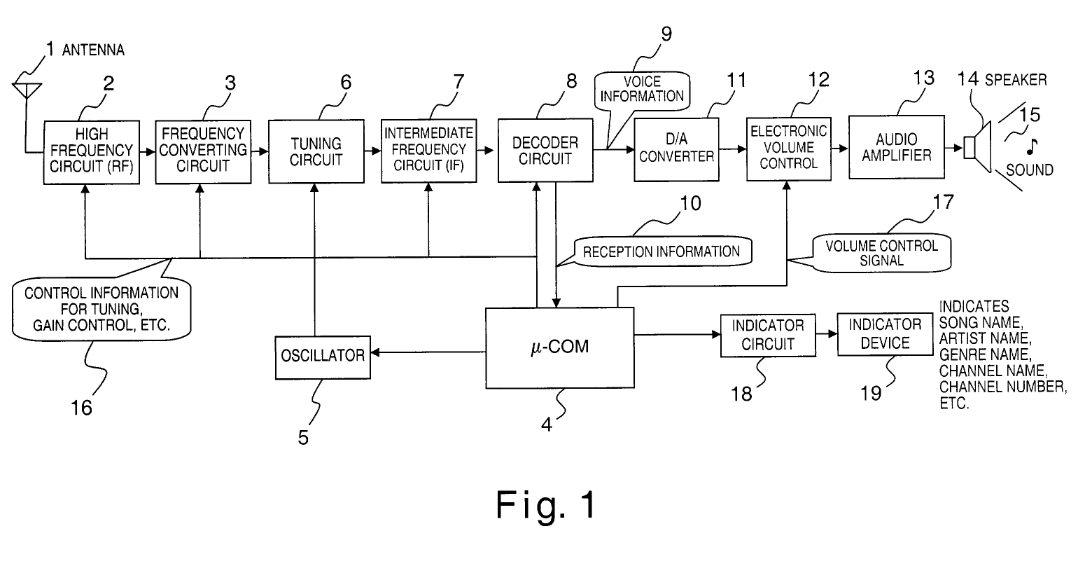

Referring initially to FIG. 1, a satellite radio with a receiving circuit is diagrammatically illustrated in accordance with a first embodiment of the present invention. Basically, the satellite radio of the present invention is designed for use in a moving vehicle and configured to avoid startling a driver and/or accompanying passengers by abrupt changes in sound volume level.

More specifically, the satellite radio of the present invention configured to receive a digital broadcast signal from a satellite, and then determine strength of the broadcast signal and regulate a sound volume level outputted in response to the strength of the broadcast signal determined. Preferably, the satellite radio of the present invention is configured to reduce, preferably mute, the sound volume level from a first predetermined output level to a second predetermined output level upon determining that the strength of the broadcast signal is below a first predetermined reception level. Once the satellite radio of the present invention determines that the strength of the broadcast signal is above a second predetermined reception level, the satellite radio gradually increases the sound volume level from the second predetermined output level. In the illustrated embodiment, the sound volume level is gradually increase from the second predetermined output level back to the first predetermined output level upon determining that the strength of the broadcast signal is above the second predetermined reception level.

The satellite radio of the present invention basically includes an antenna 1, a high frequency (RF: radio frequency) circuit 2, a frequency converting circuit 3, a microcomputer 4, an oscillator 5, a tuning circuit 6, an intermediate frequency circuit 7, a decoder circuit 8 sends reception information 10 to the microcomputer 4, a D/A converter 11 that receives voice information 9 from the decoder circuit 8, an electronic volume control 12 that receives a volume control signal 17 from the microcomputer 4, an audio amplifier 13, a speaker 14 that outputs sound 15, an indicator circuit 18 and an indicator device 19. These parts of the satellite radio of the present invention are conventional components that are well known in the art, but are controlled by the microcomputer 4 which has been programmed to carry out the present invention as discussed below. Since parts are well known in the art, these parts will not be discussed or illustrated in detail herein.

The microcomputer 4 preferably includes one or more control programs such that the microcomputer 4 is programmed to control a reception determining section and a sound volume controlling section as discussed below. The microcomputer 4 can also include other conventional components such as an input interface circuit, an output interface circuit, and storage devices such as a ROM (Read Only Memory) device and a RAM (Random Access Memory) device. The memory circuit stores processing results and control programs that are run by the processor circuit. The microcomputer 4 is operatively coupled to parts 2, 3, 6, 7 and 8 for sending various control signals or information 16 such as for tuning, gain control, etc. It will be apparent to those skilled in the art from this disclosure that the precise structure and/or algorithms for the microcomputer 4 can be any combination of hardware and software that will carry out the functions of the present invention. In other words, “means plus function” clauses as utilized in the specification and claims should include any structure or hardware and/or algorithm or software that can be utilized to carry out the function of the “means plus function” clause.

The high frequency circuit 2 selects the desired frequency from among the received signals. The frequency converting circuit 3 converts the frequency from the GHz band to the MHz band. The tuning circuit 6 is controlled by the microcomputer 4 and produces an alternating current having an intermediate frequency (IF: intermediate frequency) by synthesizing the aforementioned high frequency with a frequency generated by the oscillator 5. The intermediate frequency circuit 7 executes gain control and the like at intermediate frequencies. The decoder circuit 8 decodes a digital signal sent according to a predetermined rule.

The microcomputer 4 obtains reception information 10 from the decoder circuit 8 after the information has passed through the antenna 1, the high frequency circuit 2, the frequency conversion circuit 3, the tuning circuit 6, the intermediate frequency circuit 7, and the decoder circuit 8.

The reception information 10 includes such information as the song name, artist name, genre name, channel name, and channel number needed for indication.

The voice information 9 is converted from digital to analog by the D/A converter 11 and its volume is controlled by the electronic volume control 12. The sound 15 can be heard after the signal passes through the audio amplifier 13 and the speaker 14.

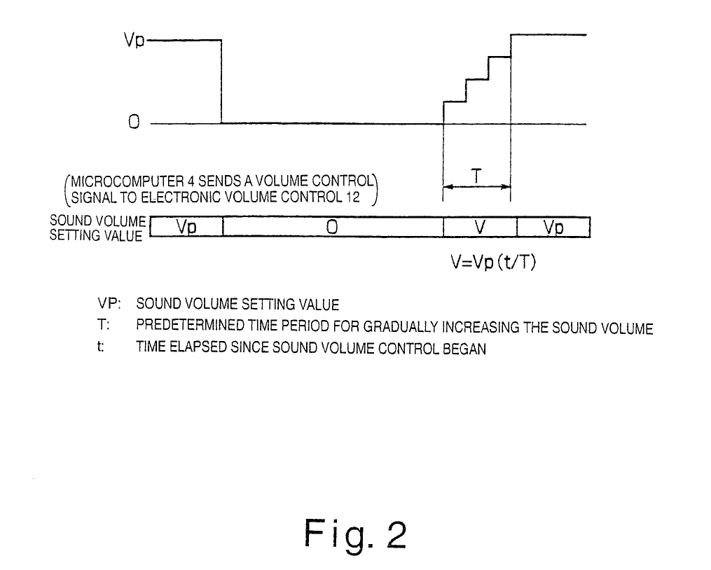

FIG. 2 illustrates the sound volume control executed in this embodiment of the satellite radio by the electronic volume control 12 and the sound volume controlling section of the microcomputer 4. The electronic volume control 12 receives a volume setting value Vp from the sound volume controlling section of the microcomputer 4 for setting a target sound volume level. The electronic volume control 12 also receives a predetermined time period T over which time period the electronic volume control 12 will execute a sound volume level control for gradually increasing the sound volume level. During this predetermined time period T, a current adjusted sound volume level V is determined by the relationship V=Vp(t/T), where t is the time that has elapsed since sound volume control began.

When the broadcast signal is blocked by an obstacle, the broadcast signal cannot be received, i.e., the reception information 10 cannot be obtained from the decoder circuit 8 (FIG. 1). The microcomputer 4 is constantly aware of the state of the broadcast signal reception.

When a state occurs in which the reception information 10 cannot be obtained, the microcomputer 4 stores the sound volume setting value Vp existing at that point in time and then transmits the volume control signal 17 to the electronic volume control 12. The volume control signal 17 is a mute signal or a signal that sets the volume to 0 (or lowers the volume). Afterwards, when the state changes such that the reception information 10 can be obtained, the microcomputer 4 transmits the volume control signal 17 to the electronic volume control 12 that gradually increases the volume from 0 to the previously stored value of the volume setting value Vp over the volume control time period T.

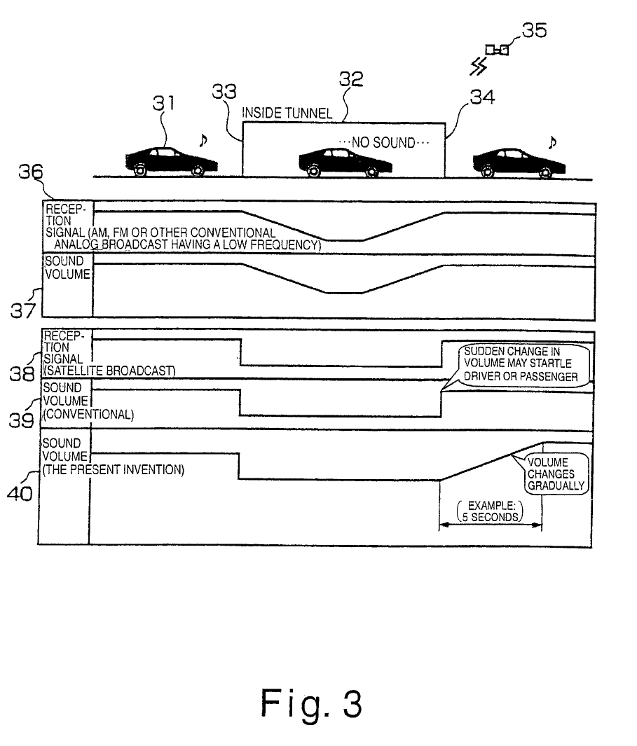

FIG. 3 compares a radio using conventional analog broadcasting technology to a satellite radio using the concept of this embodiment of accordance with the present invention. In FIG. 3, an automobile 31 is illustrated traveling through a tunnel 32 having an entrance 33 and an exit 32. The strength of a low frequency analog broadcast signal 36 such as an AM signal, an FM signal, or the like is diagrammatically illustrated as the automobile 31 travels through the tunnel 32. Likewise, a sound volume level 37 of the analog broadcast signal 36 is diagrammatically illustrated as the automobile 31 travels through the tunnel 32. In the case of an AM, FM, or other low frequency analog broadcast signal, sudden volume change is not a problem because the wavelength of the electromagnetic waves is long. Consequently, the sound volume outputted by the radio using conventional analog broadcasting technology increases gradually as the automobile 31 approaches the exit 34 of the tunnel 32 from inside the tunnel 32.

The strength of a satellite broadcast reception signal 38 and a sound volume level 39 of a satellite broadcast signal received with a conventional satellite radio is diagrammatically illustrated as the automobile 31 travels through the tunnel 32.

A sound volume level 40 of a satellite broadcast signal received with a satellite radio that embodies the present invention is diagrammatically illustrated as the automobile 31 travels through the tunnel 32. As shown in FIG. 3, the sound volume level 40 is increased gradually over a predetermined time period, for example, five seconds. As a result, it is possible to prevent the driver and accompanying passengers from being startled.

As previously described, this embodiment of a satellite radio that receives a digital broadcast signal from the satellite 35 (FIG. 3) is provided with the microcomputer 4 (FIG. 1) having the reception determining device or section and the sound volume controlling device or section. The reception determining section determines if the broadcast signal is receivable or not receivable, while the sound volume controlling section controls the sound volume level in response to the determination result of the reception determining section.

The sound volume controlling section mutes or reduces the sound volume level when the reception determining section determines that the broadcast signal is not receivable and, afterwards, gradually increases the sound volume level when the reception determining section determines that the situation has changed from one in which the broadcast signal is not receivable to one in which the broadcast signal is receivable. Therefore, this embodiment of the satellite radio can prevent startling of the driver and accompanying passengers by abrupt changes in sound volume level.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

This application claims priority to Japanese Patent Application No. 2001-349943. The entire disclosure of Japanese Patent Application No. 2001-349943 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A satellite radio comprising:
a digital broadcast receiving section configured to receive a digital broadcast signal from a satellite;
a reception determining section configured to determine strength of the broadcast signal; and
a sound volume controlling section configured to regulate a sound volume level outputted in response to the strength of the broadcast signal determined by the reception determining section.

2. The satellite radio as recited in claim 1, wherein
the sound volume controlling section is further configured to reduce the sound volume level from a first predetermined output level to a second predetermined output level when the reception determining section determines that the strength of the broadcast signal is below a first predetermined reception level.

3. The satellite radio as recited in claim 2, wherein
the sound volume controlling section is further configured to gradually increase the sound volume level from the second predetermined output level when the reception determining section determines that the strength of the broadcast signal is above a second predetermined reception level.

4. The satellite radio as recited in claim 2, wherein
the sound volume controlling section is further configured to gradually increase the sound volume level from the second predetermined output level back to the first predetermined output level when the reception determining section determines that the strength of the broadcast signal is above a second predetermined reception level.

5. The satellite radio as recited in claim 3, wherein
the sound volume controlling section is further configured to set the second predetermined output level to zero when the reception determining section determines that the strength of the broadcast signal is below the first predetermined reception level.

6. The satellite radio as recited in claim 5, wherein
the sound volume controlling section is further configured to gradually increase the sound volume level from the second predetermined output level back to the first predetermined output level when the reception determining section determines that the strength of the broadcast signal is above a second predetermined reception level.

7. The satellite radio as recited in claim 2, wherein
the sound volume controlling section is further configured to set the second predetermined output level to zero when the reception determining section determines that the strength of the broadcast signal is below the first predetermined reception level.

8. The satellite radio as recited in claim 1, wherein
the reception determining section and the sound volume controlling section are part of a microcomputer.

9. A satellite radio comprising:
digital broadcast receiving means for receiving a digital broadcast signal from a satellite;
reception determining means for determining strength of the broadcast signal; and
sound volume controlling means for regulating a sound volume level outputted in response to the strength of the broadcast signal determined by the reception determining means.

10. The satellite radio as recited in claim 9, wherein
the sound volume controlling means is further configured to reduce the sound volume level from a first predetermined output level to a second predetermined output level when the reception determining means determines that the strength of the broadcast signal is below a first predetermined reception level.

11. The satellite radio as recited in claim 10, wherein
the sound volume controlling means is further configured to gradually increase the sound volume level from the second predetermined output level when the reception determining means determines that the strength of the broadcast signal is above a second predetermined reception level.

12. The satellite radio as recited in claim 10, wherein
the sound volume controlling means is further configured to gradually increase the sound volume level from the second predetermined output level back to the first predetermined output level when the reception determining means determines that the strength of the broadcast signal is above a second predetermined reception level.

13. The satellite radio as recited in claim 11, wherein
the sound volume controlling means is further configured to set the second predetermined output level to zero when the reception determining means determines that the strength of the broadcast signal is below the first predetermined reception level.

14. The satellite radio as recited in claim 13, wherein
the sound volume controlling means is further configured to gradually increase the sound volume level from the second predetermined output level back to the first predetermined output level when the reception determining means determines that the strength of the broadcast signal is above a second predetermined reception level.

15. The satellite radio as recited in claim 10, wherein
the sound volume controlling means is further configured to set the second predetermined output level to zero when the reception determining means determines that the strength of the broadcast signal is below the first predetermined reception level.

16. A method of controlling a satellite radio comprising:
receiving a digital broadcast signal from a satellite;
determining strength of the broadcast signal; and
regulating a sound volume level outputted in response to the strength of the broadcast signal determined.

17. The method as recited in claim 16, further comprising
reducing the sound volume level from a first predetermined output level to a second predetermined output level upon determining that the strength of the broadcast signal is below a first predetermined reception level.

18. The satellite radio as recited in claim 17, further comprising
gradually increasing the sound volume level from the second predetermined output level upon determining that the strength of the broadcast signal is above a second predetermined reception level.
